(19) United States
(12) Patent Application Publication
(10) Pub. No.: US 2016/0086565 A1
(43) Pub. Date: Mar. 24, 2016

(54) DISPLAY DRIVING CIRCUIT, METHOD OF OPERATING DISPLAY DRIVING CIRCUIT, AND SYSTEM ON CHIP

(71) Applicants: Seong-Young RYU, Seoul (KR); Yong-Kyu LEE, Gwacheon-si (KR); Choong-Jae LEE, Hwaseong-si (KR)

(72) Inventors: Seong-Young RYU, Seoul (KR); Yong-Kyu LEE, Gwacheon-si (KR); Choong-Jae LEE, Hwaseong-si (KR)

(21) Appl. No.: 14/857,926

(22) Filed: Sep. 18, 2015

(30) Foreign Application Priority Data
Sep. 18, 2014 (KR) 10-2014-0124634

(51) Int. Cl. G09G 5/00; G06F 3/041; G06F 1/32

(52) U.S. Cl. CPC G09G 5/003; G06F 1/3265; G06F 1/3262; G06F 3/0412; G06F 3/0416; G09G 2330/021

(57) ABSTRACT

A display driving circuit includes a frame buffer that stores a plurality of pieces of line data, and a buffer controller. The buffer controller receives a data packet, and outputs first line data included in the data packet or second line data stored in the frame buffer as grayscale data based on flag information included in the data packet.

### CROSS-REFERENCE TO RELATED APPLICATIONS

This application claims priority under 35 U.S.C. §119 to Korean Patent Application No. 10-2014-0124634, filed on Sep. 18, 2014, the disclosure of which is incorporated by reference herein in its entirety.

### TECHNICAL FIELD

Exemplary embodiments of the inventive concept relate to a display driving circuit and a system on chip, and more particularly, to a display driving circuit which supports a partial panel self refresh mode, a method of operating the display driving circuit, and a system on chip.

### DISCUSSION OF THE RELATED ART

As image resolution is increased, the amount of data transferred between a host, such as an application processor and a system on chip, and a display driving circuit is increased. Such an increase in the amount of data transferred induces an increase in power consumption for both the host and the display driving circuit.

The demand for low power consumption has been continually increased for various mobile devices, such as smartphones and tablets. Mobile devices may include an application processor as a host, and a display driving circuit for driving a display operation. The power consumption for image display operations in mobile devices may account for a significant portion of the entire power consumption of the mobile devices.

### SUMMARY

Exemplary embodiments of the inventive concept provide a display driving circuit which may improve display operating characteristics and reduce power consumption, a method of operating the same, and a system on chip.

According to an exemplary embodiment of the inventive concept, a display driving circuit includes a frame buffer storing a plurality of pieces of line data, and a buffer controller which receives a data packet, and according to a result of detecting flag information included in the data packet, outputs line data included in the data packet or the line data stored in the frame buffer as grayscale data.

According to an exemplary embodiment of the inventive concept, a display driving circuit includes a frame buffer storing frame data including a plurality of pieces of line data, and a buffer controller controlling a display operation such that the display operation is performed using the frame data stored in the frame buffer, regardless of external communication, while in a first mode, and such that the display operation is performed using the line data stored in the frame buffer or line data provided from the outside in units of a line, while in a second mode.

According to an exemplary embodiment of the inventive concept, a system on chip includes a memory control module and a display control module. The display control module compares pieces of line data of a first frame and pieces of line data of a second frame, transfers a data packet which does not include the line data of the second frame with respect to a line having the same data, and transfers a data packet which includes the line data of the second frame with respect to a line having different data.

According to an exemplary embodiment of the inventive concept, a method of operating a display driving circuit includes receiving data packets with respect to a plurality of lines of a current frame, performing a display operation using line data included in the received data packets with respect to some of the plurality of lines of the current frame, and performing the display operation using line data stored in an internal frame buffer with respect to others of the plurality of lines of the current frame.

According to an exemplary embodiment of the inventive concept, a display driving circuit includes a frame buffer configured to store a plurality of pieces of line data, and a buffer controller configured to receive a data packet, and output first line data included in the data packet or second line data stored in the frame buffer as grayscale data based on flag information included in the data packet.

In an exemplary embodiment, the plurality of pieces of line data stored in the frame buffer includes line data of a plurality of lines of a first frame. Further, the buffer controller is configured to receive a plurality of data packets corresponding to a plurality of lines of a second frame, and control a display operation such that a portion of the second frame is displayed using the second line data stored in the frame buffer and another portion of the second frame is displayed using third line data included in the plurality of data packets corresponding to the second frame based on flag information included in the plurality of data packets.

In an exemplary embodiment, the buffer controller includes a flag detection unit configured to detect the flag information included in the data packet, and an access control unit configured to control access of the frame buffer based on the flag information.

In an exemplary embodiment, the access control unit is configured to read the second line data stored in the frame buffer and provide the second line data as the grayscale data in response to the flag information having a first value, and provide the first line data included in the data packet as the grayscale data in response to the flag information having a second value.

In an exemplary embodiment, the access control unit is configured to write the first line data included in the data packet to the frame buffer in response to the flag information having the second value.

In an exemplary embodiment, the buffer controller is configured to refresh line data corresponding to a first line of a frame and stored in the frame buffer in response to the flag information included in the data packet corresponding to the first line having a first value, and the buffer controller is further configured to update the line data corresponding to the first line and stored in the frame buffer with the first line data included in the data packet in response to the flag information included in the data packet having a second value.

In an exemplary embodiment, the display driving circuit further includes a source driver configured to receive the grayscale data, and generate a grayscale voltage provided to a display panel by processing the received grayscale data.

In an exemplary embodiment, the display driving circuit is a timing controller configured to provide the grayscale data to a source driver.

In an exemplary embodiment, the data packet is encoded and does not include line data of a current frame when line data of a previous frame and the line data of the current frame are identical.

According to an exemplary embodiment of the inventive concept, a display driving circuit includes a frame buffer configured to store frame data including a plurality of pieces of line data, and a buffer controller. The buffer controller is configured to control a display operation such that the display operation is performed using the frame data stored in the frame buffer and not using external line data from outside of the display driving circuit while in a first mode, and such that the display operation is performed using at least one of the frame data stored in the frame buffer and the external line data provided from outside of the display driving circuit on a line-by-line basis while in a second mode.

In an exemplary embodiment, the first mode is a panel self-refresh (PSR) mode in which data communication with an application processor is disabled.

In an exemplary embodiment, the buffer controller is configured to receive a plurality of data packets corresponding to a plurality of lines of a current frame, and at least some of the data packets do not include line data.

In an exemplary embodiment, the buffer controller is configured to skip a line data writing operation with respect to the frame buffer, or perform the line data writing operation with respect to the frame buffer using the external line data included in a data packet provided from outside of the display driving circuit, according to flag information included in the data packet.

In an exemplary embodiment, the buffer controller is configured to read the line data stored in the frame buffer and output the read line data as grayscale data in response to determining that the flag information has a first value, and output the external line data included in the data packet as the grayscale data in response to determining that the flag information has a second value.

In an exemplary embodiment, the plurality of pieces of line data stored in the frame buffer includes a first plurality of pieces of line data corresponding to a previous frame and a second plurality of pieces of line data corresponding to a current frame, and the buffer controller is configured to selectively receive some of the second plurality of pieces of line data corresponding to the current frame.

In an exemplary embodiment, the buffer controller is configured to provide local first line data stored in the frame buffer as grayscale data in response to determining that first line data of the previous frame and first line data of the current frame are identical, and provide external first line data provided from outside of the display driving circuit as the grayscale data in response to determining that the first line data of the previous frame and the first line data of the current frame are different.

According to an exemplary embodiment of the inventive concept, a system on chip includes a memory control module and a display control module. The display control module is configured to compare pieces of line data of a first frame with pieces of line data of a second frame, transfer a first data packet which does not include a first piece of the line data of the second frame that corresponds to a first piece of the line data of the first frame in response to a first comparison result indicating that the first pieces of the line data are identical, and transfer a second data packet which includes a second piece of the line data of the second frame that corresponds to a second piece of the line data of the first frame in response to the first comparison result indicating that the second pieces of the line data are different.

In an exemplary embodiment, the first and second data packets each include flag information having values indicating the first comparison result.

In an exemplary embodiment, the display control module includes a comparison unit and a packet generating unit. The comparison unit is configured to compare a piece of the line data of the second frame corresponding to a current frame with a piece of the line data of the first frame corresponding to a previous frame. The packet generating unit is configured to generate a third data packet. The third data packet includes flag information having a first value indicating that the piece of the line data of the second frame corresponding to the current frame and the piece of the line data of the first frame corresponding to the previous frame are identical, and does not include the piece of the line data of the second frame corresponding to the current frame, in response to a second comparison result indicating that the piece of the line data of the second frame corresponding to the current frame and the piece of the line data of the first frame corresponding to the previous frame are identical.

In an exemplary embodiment, the display control module includes a comparison unit configured to compare the pieces of line data of the first frame with the pieces of line data of the second frame, and a panel self-refresh (PSR) management unit configured to prevent the first and second data packets from being output when all of the pieces of line data of the first frame and all of the pieces of line data of the second frame are identical.

In an exemplary embodiment, the memory control module is configured to provide the pieces of line data of the first frame and the pieces of line data of the second frame to the display control module by accessing an internal memory or an external memory.

According to an exemplary embodiment of the inventive concept, a method of operating a display driving circuit includes receiving a plurality of data packets corresponding to a plurality of lines of a current frame, performing a display operation using first line data included in the received data packets for a first group of the plurality of lines of the current frame, and performing the display operation using second line data stored in an internal frame buffer for a second group of the plurality of lines of the current frame.

In an exemplary embodiment, the method further includes detecting flag information included in each of the data packets. A line of the plurality of lines is displayed using the second line data stored in the internal frame buffer in response to detecting that flag information of a corresponding data packet has a first value, and the line is displayed using the first line data included in the corresponding data packet in response to detecting that the flag information of the corresponding data packet has a second value.

In an exemplary embodiment, a plurality of pieces of line data of a previous frame are stored in the internal frame buffer, and the method further includes writing third line data of the current frame into the internal frame buffer in response to determining that the third line data of the current frame and the plurality of pieces of line data of the previous frame are different.

In an exemplary embodiment, a plurality of pieces of line data of a previous frame are stored in the internal frame buffer, and the method further includes performing a refresh operation with respect to the plurality of pieces of line data of the previous frame stored in the frame buffer in response to determining that the first and second line data of the current frame and the plurality of pieces of line data of the previous frame are identical.

According to an exemplary embodiment of the inventive concept, a method of operating a display driving circuit includes comparing pieces of line data of a first frame with pieces of line data of a second frame, transferring a first data packet which does not include a first piece of the line data of the second frame that corresponds to a first piece of the line data of the first frame in response to a first comparison result indicating that the first pieces of the line data are identical, and transferring a second data packet which includes a second piece of the line data of the second frame that corresponds to a second piece of the line data of the first frame in response to the first comparison result indicating that the second pieces of the line data are different.

In an exemplary embodiment, the first and second data packets each include flag information having values indicating the first comparison result.

In an exemplary embodiment, the method further includes comparing a piece of the line data of the second frame corresponding to a current frame with a piece of the line data of the first frame corresponding to a previous frame, and generating a third data packet. The third data packet includes flag information having a first value indicating that the piece of the line data of the second frame corresponding to the current frame and the piece of the line data of the first frame corresponding to the previous frame are identical, and does not include the piece of the line data of the second frame corresponding to the current frame, in response to a second comparison result indicating that the piece of the line data of the second frame corresponding to the current frame and the piece of the line data of the first frame corresponding to the previous frame are identical.

In an exemplary embodiment, the method further includes preventing the first and second data packets from being output when all of the pieces of line data of the first frame and all of the pieces of line data of the second frame are identical.

### BRIEF DESCRIPTION OF THE DRAWINGS

The above and other features of the inventive concept will become more apparent by describing in detail exemplary embodiments thereof with reference to the accompanying drawings, in which:

FIG. 1 is a block diagram of an example of a system including a display driving circuit according to an exemplary embodiment of the inventive concept.

FIG. 2 is a block diagram of a system on chip (SoC) according to an exemplary embodiment of the inventive concept.

FIG. 3 is a block diagram of an example of a display control module of FIG. 2 according to an exemplary embodiment of the inventive concept.

FIG. 4 is a block diagram of an image processing system according to an exemplary embodiment of the inventive concept.

FIG. 5 shows an example of a data packet provided to a display driving circuit according to an exemplary embodiment of the inventive concept.

FIGS. 6A and 6B are block diagrams showing detailed views of display driving circuits according to exemplary embodiments of the inventive concept.

FIG. 7 shows an example of a display operation according to an exemplary embodiment of the inventive concept.

FIG. 8 is a flowchart of a method of operating a system on chip (SoC) according to an exemplary embodiment of the inventive concept.

FIG. 9 is a flowchart of a method of operating a display driving circuit according to an exemplary embodiment of the inventive concept.

FIGS. 10 through 12 are block diagrams of display systems including display driving circuits according to exemplary embodiments of the inventive concept.

FIG. 13 is a block diagram of an image processing system according to an exemplary embodiment of the inventive concept.

FIGS. 14A, 14B, and 14C show an example of writing and reading operations of a frame buffer according to exemplary embodiments of the inventive concept.

FIGS. 15A and 15B are views of another example of writing and reading operations of a frame buffer according to exemplary embodiments of the inventive concept.

FIG. 16 is a flowchart showing a method of operating a display driving circuit according to an exemplary embodiment of the inventive concept.

FIG. 17 is a block diagram of an image processing system according to an exemplary embodiment of the inventive concept.

FIG. 18 is a block diagram of a system on chip (SoC) according to an exemplary embodiment of the inventive concept.

FIG. 19 shows an example of a portable terminal in which a system on chip (SoC) and a display driving circuit according to an exemplary embodiment of the inventive concept are mounted.

### DETAILED DESCRIPTION OF THE EXEMPLARY EMBODIMENTS

Exemplary embodiments of the inventive concept will be described more fully hereinafter with reference to the accompanying drawings. In the drawings, the same reference numerals may denote the same elements, and the thicknesses of layers and regions and the sizes of components may be exaggerated for clarity.

It will be understood that the terms “first,” “second,” “third,” etc. are used herein to distinguish one element from another, and the elements are not limited by these terms. Thus, a “first” element in an exemplary embodiment may be described as a “second” element in another exemplary embodiment. It will be further understood that the modules, units, components, elements, and function/intellectual property (IP) blocks described herein with reference to the exemplary embodiments may be embodied as part of the same circuit or different circuits.

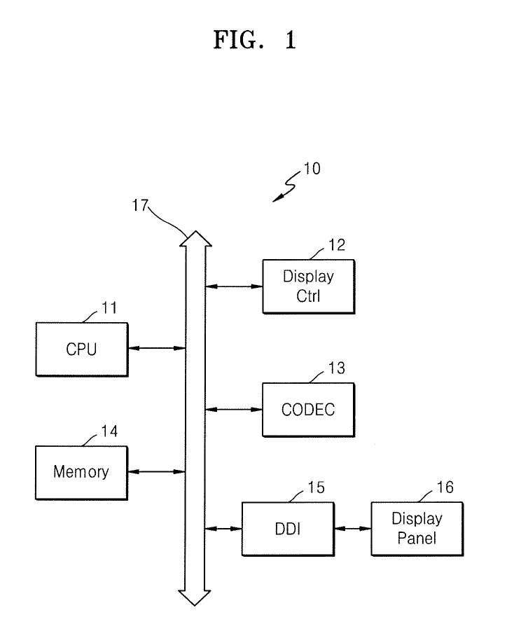

FIG. 1 is a block diagram of an example of a system including a display driving circuit according to an exemplary embodiment of the inventive concept. The system of FIG. 1 may correspond to various systems including a display driving circuit. For example, various mobile devices, such as a digital camera, a portable camcorder, a smartphone, etc. may be implemented using the system of FIG. 1. Hereinafter, it is assumed that the system of FIG. 1 is a mobile device 10. However, exemplary embodiments of the inventive concept are not limited thereto.

As illustrated in FIG. 1, the mobile device 10 may include a central processing unit 11, a display control module 12, a codec module 13, a memory 14, a display driving circuit (DDI) 15, and a display panel 16. Various function blocks included in the mobile device 10 may exchange signals with one another. For convenience of explanation, it is illustrated in FIG. 1 that various function blocks share a bus 17. However, exemplary embodiments of the inventive concept are not limited thereto. For example, in exemplary embodiments, some of the function blocks may exchange signals through an additional signal transferring line.

The mobile device 10 may include various other function blocks for performing other functions. For example, when the mobile device 10 performs a communication function, the mobile device 10 may further include a communication module. The mobile device 10 may further include, for example, a power management module, a clock module, or a graphic processing unit (GPU).

In an exemplary embodiment, the display driving circuit 15 may receive an image signal from the inside or the outside of the mobile device 10, and may process the received image signal to output a signal (e.g., a grayscale voltage) which is displayed on the display panel 16. For example, the display driving circuit 15 may include a gate driver for driving rows of the display panel 16 and a source driver for driving columns of the display panel 16. The display driving circuit 15 may further include a timing controller for generating various timing information for controlling a display operation.

The central processing unit 11 may control the entire operation of the mobile device 10. For example, the central processing unit 11 may execute programs and/or data stored in a memory embedded in the central processing unit 10 or the memory 14 disposed outside of the central processing unit 11. In exemplary embodiments, the central processing unit 11 may include, for example, a multi-core processor. The multi-core processor may be one computing component having two or more separate processors. The multi-core processor may drive a plurality of accelerators at the same time, and thus, the mobile device 10 including the multi-core processor may perform multi-acceleration.

The display control module 12 may perform various operations related to a display operation. For example, the display control module 12 may receive at least one piece of frame data, perform a processing operation with respect to the received piece of frame data, and generate a data packet from the processing operation and output the generated data packet. The display driving circuit 15 may drive the display panel 16 according to the data packet output from the display control module 12.

The codec module 13 may encode or decode various image signals generated in the mobile device 10 or various image signals provided from outside of the mobile device 10. In an exemplary embodiment, the codec module 13 may encode image signals and the encoded image signals may be provided to a destination outside of the mobile device 10. In an exemplary embodiment, encoded image signals may be received from a source outside of the mobile device 10, and the codec module 13 may decode the received encoded image signals so that an image may be output via the display panel 16.

The memory 14 may store an operating system (OS) related to the driving of the mobile device 10, as well as various other programs. The memory 14 may store an image signal to be output on the display panel 16. For example, the memory 14 may include a storage space in which image data included in at least one frame may be stored. In response to a data access request of the various function blocks included in the mobile device 10, image data may be stored in the memory 14 or image data may be read from the memory 14.

Although it is illustrated in FIG. 1 that various function blocks of the mobile device 10 for performing various functions are separate elements, exemplary embodiments are not limited thereto. For example, in exemplary embodiments, one or more function blocks may be combined into the same function block. Since one or more function blocks illustrated in FIG. 1 may process an image signal, the one or more function blocks of FIG. 1 may be referred to herein as image processing devices (or image processing systems). In exemplary embodiments, one or more of the central processing unit 11, the display control module 12, the codec module 13, other function blocks illustrated in FIG. 1, and other function blocks not illustrated in FIG. 1 may be implemented as a system on chip (SoC) and may be integrated in a semiconductor chip. In exemplary embodiments, the display driving circuit 15 may be included in the SoC. According to exemplary embodiments, the SoC performing an image data processing operation may correspond to an application processor controlling the entire function of the mobile device 10.

According to exemplary embodiments, the display control module 12 may receive frame data stored in an embedded memory of the display control module 12 and/or the memory 14, and may receive two pieces of frame data corresponding to at least two frames. The display control module 12 may perform a comparison operation with respect to the received two pieces of frame data and may control a data output operation according to a result of the comparison. One frame may include a plurality of lines. The entire data included in one frame may be defined as frame data, and data included in each line may be defined as line data.

According to exemplary embodiments, when a display operation of a current frame is performed, a previous frame (e.g., a first frame) and the current frame (e.g., a second frame) may be compared with each other in terms of a line data unit, and a line data output operation may be controlled according to a result of the comparison. For example, fist line data of the second frame and first line data of the first frame may be compared with each other. When the first line data of the first and second frames is the same (e.g., identical), the first line data of the second frame may not be provided to the display driving circuit 15, and the display driving circuit 15 may perform a display operation using the first line data of the first frame stored in a storage device (e.g., a frame buffer) inside of the display driving circuit 15. Thus, the same line data is not provided twice to the display driving circuit 15. Alternatively, when the first line data of the first and second frames is different, the first line data of the second frame may be provided to the display driving circuit 15.

Comparison operations may be performed with respect to the entire line data of the second frame in substantially the same manner as the comparison operation described above. For example, when one frame includes M lines (where M is an integer greater than or equal to 2), M pieces of line data of the second frame and M pieces of line data of the first frame may be compared. According to a result of the comparison, some of the pieces of line data of the second frame may not be provided to the display driving circuit 15, and other pieces of line data of the second frame may be provided to the display driving circuit 15.

The display control module 12 and the display driving circuit 15 may communicate data according to a predetermined protocol. For example, the display control module 12 and the display driving circuit 15 may communicate with each other according to the embedded display port (eDP) standard, or may communicate with each other according to other standards such as, for example, the MIPI standard. The display control module 12 may generate a data packet by performing an encoding operation with respect to line data according to a predetermined protocol. The data packet may include line data and at least one piece of flag information. The at least one piece of flag information may include a first flag indicating whether line data is included in the data packet.

According to exemplary embodiments, the display driving circuit 15 may receive the data packet from the display control module 12 and may provide a grayscale voltage to the display panel 16 by performing data processing with respect to the received data packet in order to display the current frame (e.g., the second frame). The display driving circuit 15 may drive a corresponding line of the display panel 16 using line data stored in the frame buffer when line data is not included in the received data packet. Alternatively, when line data is included in the received data packet, the display driving circuit 15 may drive a corresponding line of the display panel 16 using the line data included in the data packet.

According to exemplary embodiments, since some pieces of line data of one frame are communicated between the display control module 12 and the display driving circuit 15 instead of all pieces of line data of two frames, an amount of data transferred and the power consumption due to the data communication may be reduced. Further, since the display driving circuit 15 according to exemplary embodiments stores pieces of line data with respect to a plurality of lines corresponding to the current frame into the frame buffer, the number of writing operations with respect to the frame buffer may be reduced, and thus, the power consumption necessary for accessing the frame buffer may be decreased.

The mobile device 10 (e.g., a smartphone) frequently displays a still image. Further, when an image of the display of the mobile device 10 is changed, often only a portion of the image in some regions of the display is actually changed. According to exemplary embodiments of the inventive concept, when the frame data is only partially changed, the display control module 12 does not transfer the entire frame data and instead transfers only the pieces of line data in which a change occurs. As a result, in exemplary embodiments, data processing efficiency may be increased and power consumption may be reduced.

A detailed operation of an image processing system according to exemplary embodiments of the inventive concept described above will be described herein.

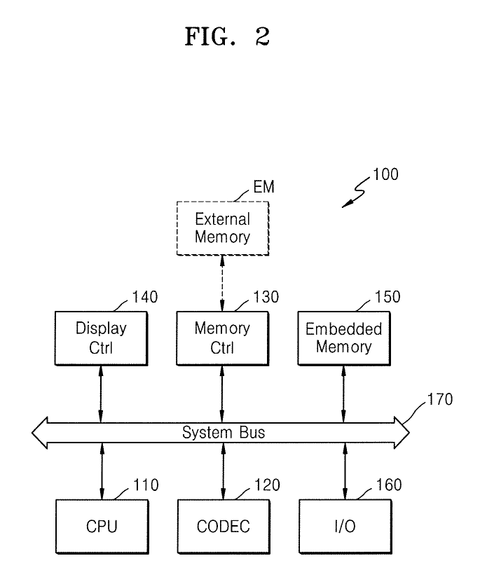

FIG. 2 is a block diagram of an SoC 100 according to an exemplary embodiment of the inventive concept. The SoC 100 of FIG. 2 may correspond to, for example, an application processor (AP).

The SoC 100 may include a plurality of intellectual property (IP) blocks. Each of the plurality of IP blocks may perform a specific function. The SoC 100 may further include a system bus 170. Various signals may be exchanged between the IP blocks included in the SoC 100 via the system bus 170.

The system bus 170 may be realized as a bus applying a protocol having predetermined bus standards. The bus standards may correspond to, for example, an advanced microcontroller bus architecture (AMBA) protocol of the advanced RISC machine (ARM). The type of bus applying the AMBA protocol may be, for example, advanced high-performance bus (AHB), advanced peripheral bus (APB), advanced extensible interface (AXI), AXI4, or AXI coherency extensions (ACE). The AXI is an interface protocol and provides a multiple outstanding address function and a data interleaving function. In addition, the system bus 170 may utilize other types of protocols such as, for example, SONIC uNetwork or IBM CoreConnect, or an OCP-IP open core protocol.

As illustrated in FIG. 2, the SoC 100 may include various IP blocks for performing a function of the application processor. For example, the SOC 100 may include a central processing unit 110, a codec module 120, a memory control module 130, a display control module 140, an embedded memory 150, and an input/output module 160. The IP blocks of the SoC 100 may be connected with one another via the system bus 170 in the SoC. According to exemplary embodiments, the SoC 100 may not include some of the IP blocks illustrated in FIG. 2, or may include other IP blocks not illustrated in FIG. 2.

The embedded memory 150 is a memory installed in the SoC 100 and may store various programs, instructions, data, etc. in a similar manner as the memory 14 (e.g., an external memory) of FIG. 1. The embedded memory 150 may store at least one piece of frame data to be displayed. The embedded memory 150 may be implemented as, for example, a volatile memory and/or a nonvolatile memory.

The memory control module 130 may perform an interface with an external memory EM. For example, according to exemplary embodiments, the memory control module 130 may access at least two pieces of frame data for the data comparison operation, and may provide the at least two pieces of frame data to other IP blocks via the system bus 170.

The display control module 140 may control an operation of an external display device. For example, the display control module 140 may receive at least two pieces of frame data and perform the comparison and output operations as described above. For example, the display control module 140 may compare data of a previous frame (e.g., a first frame) and data of a current frame (e.g., a second frame) for a line unit, and may selectively output only some pieces of line data of the second frame (e.g., pieces in which a data change occurs) according to a result of the comparison. Further, as in the above-described exemplary embodiments, the display control module 140 may generate a data packet selectively including line data, and the data packet may include flag information indicating whether line data is included in the packet. The generated data packet may be provided to the external device (e.g., a display device) via the input/output module 160.

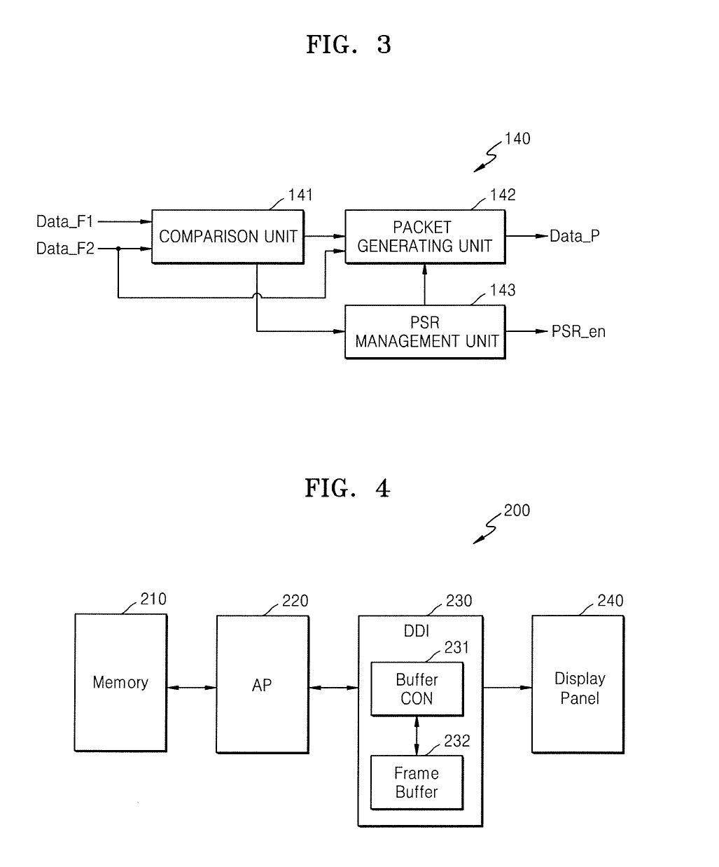

FIG. 3 is a block diagram of an example of the display control module 140 of FIG. 2 according to an exemplary embodiment of the inventive concept.

As illustrated in FIG. 3, the display control module 140 may include a comparison unit 141, a packet generating unit 142, and a panel self-refresh (PSR) management unit 143. The comparison unit 141 receives first frame data Data Fl and second frame data Data_F2, and performs a comparison operation with respect to the first frame data Data_F1 and the second frame data Data_F2. The first frame data Data_F1 may include a plurality of pieces of line data and the second frame data Data_F2 may include a plurality of pieces of line data.

The comparison unit 141 performs a comparison operation with respect to the first frame data Data_F1 and the second frame data Data_F2 for a line unit and outputs a result of the comparison. The packet generating unit 142 performs a data packet generation operation based on the result of the comparison of the comparison unit 141. For example, the packet generating unit 142 receives the second frame data Data_F2 and generates a data packet Data_P in which line data is included or a data packet Data_P in which line data is not included based on the result of the comparison of the comparison unit 141. The packet generating unit 142 generates a plurality of data packets Data_P corresponding to the plurality of pieces of line data of the second frame data Data_F2. For example, when first line data of the first frame data Data_F1 and first line data of the second frame data Data_F2 are the same, the packet generating unit 142 may generate a first data packet Data_P including flag information having a first value (e.g., a value indicating that the first line data is the same), including the first line data of the first frame data Data_F1, and not including the first line data of the second frame data Data_F2. Alternatively, when second line data of the first frame data Data_F1 and second line data of the second frame data Data_F2 are different, the packet generating unit 142 may generate a second data packet Data_P including flag information having a second value (e.g., a value indicating that the second line data is different) and including both the second line data of the first frame data Data_F1 and the second line data of the second frame data Data_F2.

The PSR management unit 143 may activate a signal (e.g., a PSR enable signal PSR_en) instructing a panel self-refresh mode based on the result of the comparison of the comparison unit 141. When continuous frames correspond to the same image, a panel self-refresh mode may be entered into and the PSR management unit 143 may activate the PSR enable signal PSR_en for enabling the panel self-refresh mode, and may provide the PSR enable signal PSR_en to an external device (e.g., a display driving circuit). In exemplary embodiments, while in the panel self-refresh mode, the display driving circuit may not have to receive frame data from the outside and may use frame data stored in an internal frame buffer in order to perform a display operation. In the panel self-refresh mode, an interface device for communicating with a host (e.g., an application processor) in the display driving circuit may not be activated.

The packet generating unit 142 may selectively perform the data packet generation operation based on the PSR enable signal PSR_en. For example, when the panel self-refresh mode is entered into, a data packet does not have to be provided to the display driving circuit. Thus, the packet generating unit 142 may not perform the data packet generation operation according to the PSR enable signal PSR_en.

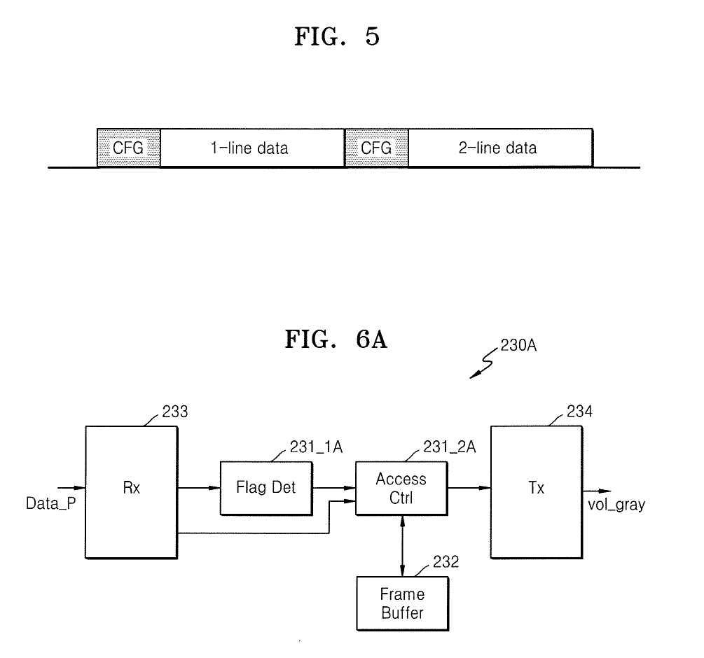

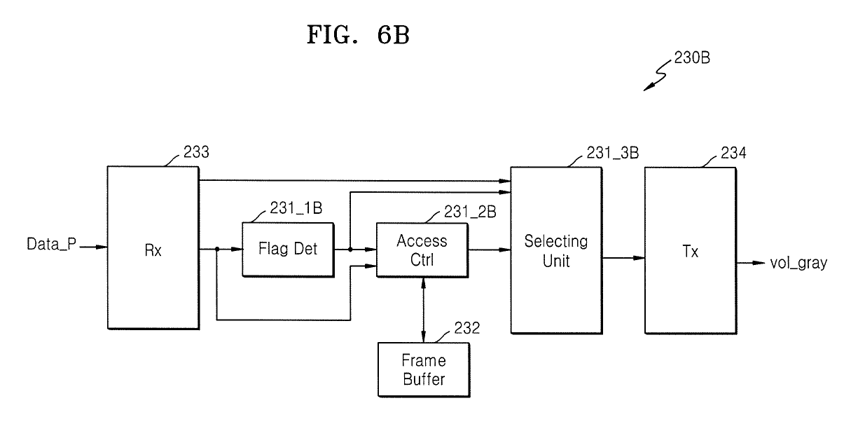

FIG. 4 is a block diagram of an image processing system 200 according to an exemplary embodiment of the inventive concept. FIG. 5 shows an example of a data packet provided to a display driving circuit according to an exemplary embodiment of the inventive concept. As illustrated in FIG. 4, the image processing system 200 may include a memory 210, an application processor 220, a display driving circuit (DDI) 230, and a display panel 240. The display driving circuit 230 may include a buffer controller 231 and a frame buffer 232. The display driving circuit 230 and the display panel 240 may form a display device. As illustrated in FIG. 5, each data packet may include configuration data CFG and line data. The configuration data CFG may include various information related to a display operation in addition to the above-described flag information. For example, the configuration data CFG may include information such as, for example, a line start signal indicating a transfer of line data or a waiting signal indicating a transfer waiting time.

The application processor 220 may access frame data stored in the memory 210. The memory 210 may store pieces of frame data corresponding to at least two frames. The application processor 220 may provide a data packet including line data or a data packet not including line data to the display driving circuit 230 based on the operation of comparing data for a line unit, as described above.

The frame buffer 232 may store frame data of a frame previous to a frame which is to be displayed currently. When one frame includes M lines (where M is an integer greater than or equal to 2) and the frame buffer 232 stores one piece of frame data, the frame buffer 232 may store M pieces of line data. The frame data stored in the frame buffer 232 may be data of a frame previous to a frame which is to be currently displayed, or older data (e.g., data of a frame that is secondly previous or more previous to the frame which is to be currently displayed). The buffer controller 231 may process a data packet provided from the outside, and may write line data in the memory 210 or read line data from the memory 210.

The buffer controller 231 detects flag information of the data packet received from the outside in order to display a plurality of lines of a current frame, and controls an access operation of the frame buffer 232 according to a result of the detection. For example, when line data of the current frame (e.g., first line data) and first line data of a previous frame are the same, the buffer controller 231 detects flag information having a first value (e.g., a value indicating that the line data is the same) and reads the first line data stored in the frame buffer 232 to provide the first line data to the display panel 240. Alternatively, when the first line data of the current frame and the first line data of the previous frame are different, the first line data of the current frame is included in the data packet, and the buffer controller 231 detects flag information having a second value (e.g., a value indicating that the line data is different), and provides the first line data of the current frame, which is included in the data packet, to the display panel 240. Additional data processing (e.g., generating a grayscale voltage) may be performed with respect to the line data read from the frame buffer 232 or the line data included in the data packet, and the generated grayscale voltage may be provided to the display panel 240.

In exemplary embodiments, when the first line data of the current frame is included in the data packet (e.g., in a case in which the first line data of the current frame and the first line data of the previous frame are different), the buffer controller 231 may write the first line data included in the data packet into the frame buffer 232 to update the first line data, and re-read the updated first line data of the current frame and provide the updated first line data of the current frame to the display panel 240.

In exemplary embodiments, when the first line data of the current frame and the first line data of the previous frame are the same, the buffer controller 231 may read the first line data of the previous frame stored in the frame buffer 232, and provide the first line data of the previous frame to the display panel 240 without an additional writing operation with respect to the frame buffer 232. In exemplary embodiments, when the first line data of the current frame and the first line data of the previous frame are the same, the buffer controller 231 may perform a refresh operation with respect to the first line data stored in the frame buffer 232, and then may read the first line data stored in the frame buffer 232 to provide the read first line data to the display panel 240. In exemplary embodiments, when the first line data of the current frame and the first line data of the previous frame are the same, the buffer controller 231 may read the first line data stored in the frame buffer 232 and provide the read first line data to the display panel 240, and then may perform a refresh operation with respect to the first line data stored in the frame buffer 232. In exemplary embodiments, as a result of using such a refresh operation, even when the frame buffer 232 is implemented as a nonvolatile memory such as, for example, DRAM, data loss occurring as a result of particular line data not being updated for a predetermined period of time may be prevented.

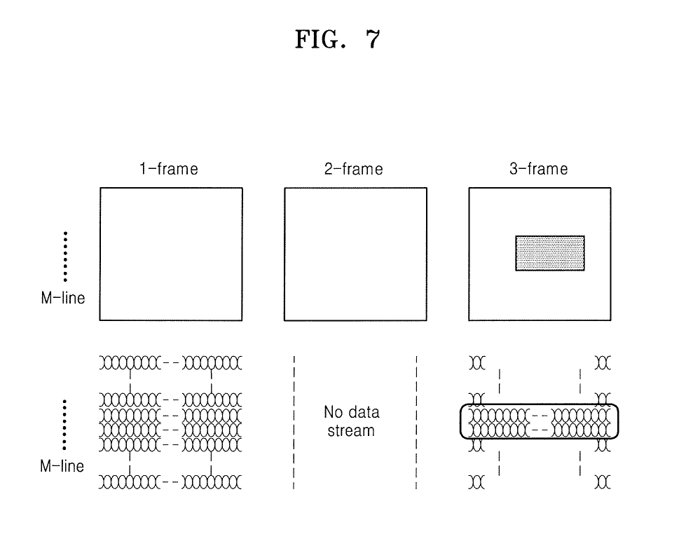

FIGS. 6A and 6B are block diagrams showing a detailed view of a display driving circuit 230A and a display driving circuit 230B according to exemplary embodiments of the inventive concept.

As illustrated in FIG. 6A, in an exemplary embodiment, the display driving circuit 230A may include a receiving unit 233, a transferring unit 234, and the frame buffer 232. The display driving circuit 230A may further include a flag detection unit 231_1A and an access control unit 231_2A, which are included in the buffer controller 231 of FIG. 4.

The flag detection unit 231_1A detects flag information included in a received data packet Data_P and outputs a result of the detection. The access control unit 231_2A performs an access operation with respect to the frame buffer 232 according to the result of the detection of the flag detection unit 231_1A. As described above, when the flag information having a first value indicating that the line data of the previous frame and the line data of the current frame are the same, the access control unit 231_2A reads the line data from the frame buffer 232 and outputs the read line data via the transferring unit 234. Alternatively, when the flag information having a second value indicating that the line data of the previous frame and the line data of the current frame are different, the access control unit 231_2A may update the line data included in the data packet Data_P in a corresponding region of the frame buffer 232 and output the updated line data via the transferring unit 234.

FIG. 6B illustrates an example in which the display driving circuit 230B further includes a selecting device. As illustrated in FIG. 6B, the display driving circuit 230B may include the receiving unit 233, the transferring unit 234, the frame buffer 232, a flag detection unit 231_1B, an access control unit 231_2B, and a selecting unit 231_3B.

The flag detection unit 231_1B may detect flag information included in a received data packet Data_P and provide a result of the detection to the access control unit 231_2B and the selecting unit 231_3B. According to exemplary embodiments, the access control unit 231_2B may perform an access operation with respect to the frame buffer 232 according to the result of the detection, and may provide the line data read from the frame buffer 232 to the selecting unit 231_3B. For example, the access control unit 231_2B may selectively read the line data from the frame buffer 232 when the flag information has a first value.

The selecting unit 231_3B may receive the line data included in the received data packet Data_P received via the receiving unit 233 and the line data read from the frame buffer 232. The selecting unit 231_3B may selectively output any one piece of line data based on a result of detecting the flag information. Accordingly, when displaying a current frame, some of a plurality of lines of the current frame may be displayed using pieces of line data of a previous frame stored in the frame buffer 232, as described above. Alternatively, other pieces of the plurality of lines of the current frame may be displayed using pieces of line data of the current frame included in the data packet Data_P received from the outside.

According to exemplary embodiments, an additional data processing operation may be performed with respect to the line data from the access control units 231_2A and 231_2B, and a grayscale voltage vol_gray for driving column lines of a display panel may be provided to the display panel via the transferring unit 234.

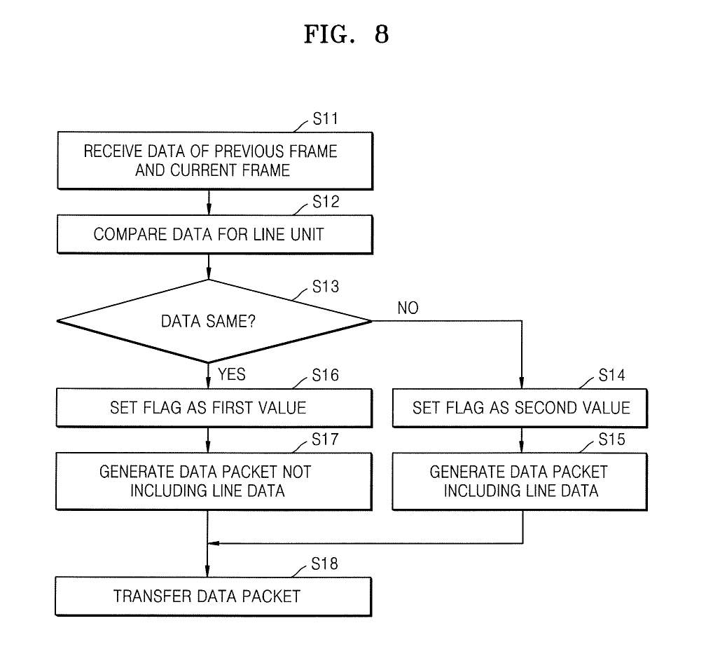

FIG. 7 shows an example of a display operation according to an exemplary embodiment of the inventive concept. In FIG. 7, a display operation corresponding to a case in which the above-described PSR mode is applied will be described.

As illustrated in FIG. 7, the entire line data (e.g., M pieces of line data, where M is an integer greater than or equal to 2) included in a first frame 1-frame is received, and the received M pieces of line data are stored in a frame buffer in order to display the first frame 1-frame.

Next, in a display operation with respect to a second frame 2-frame, data of all lines of the first frame 1-frame and the second frame 2-frame may be the same. As described above, an operation of comparing data between frames may be performed via a host such as, for example, an application processor communicating with a display driving circuit. For example, as described above, the operation of comparing the data may be performed for a line unit. Since the data of all lines of the first frame 1-frame and the second frame 2-frame is the same, the display driving circuit may enter into the PSR mode in response to a PSR enable signal from the host.

In the PSR mode, an interface device for communicating with the host may be disabled in the display driving circuit, and the second frame 2-frame may be displayed using the line data stored in the frame buffer in the display driving circuit. That is, in the PSR mode, the display driving circuit may perform the display operation without receiving data or information from the host.

Meanwhile, in a display operation with respect to a third frame 3-frame, only data of some of a plurality of lines of the second frame 2-frame and the third frame 3-frame may be different. Accordingly, with respect to the lines having the same data, line data may not be provided to the display driving circuit and only flag information indicating an instruction to display the line data stored in the frame buffer may be provided. Here, data is not transferred substantially during a section in which the line data is transferred in a transfer channel between the host and the display driving circuit, and thus, signal toggling does not occur.

Alternatively, with respect to at least one line having different data, the line data together with the flag information indicating that the line having different data are both provided to the display driving circuit. Accordingly, only line data of a portion of a frame in which an actual screen is changed is transferred, and thus, power consumption relating to the interface between the host and the display driving circuit may be reduced.

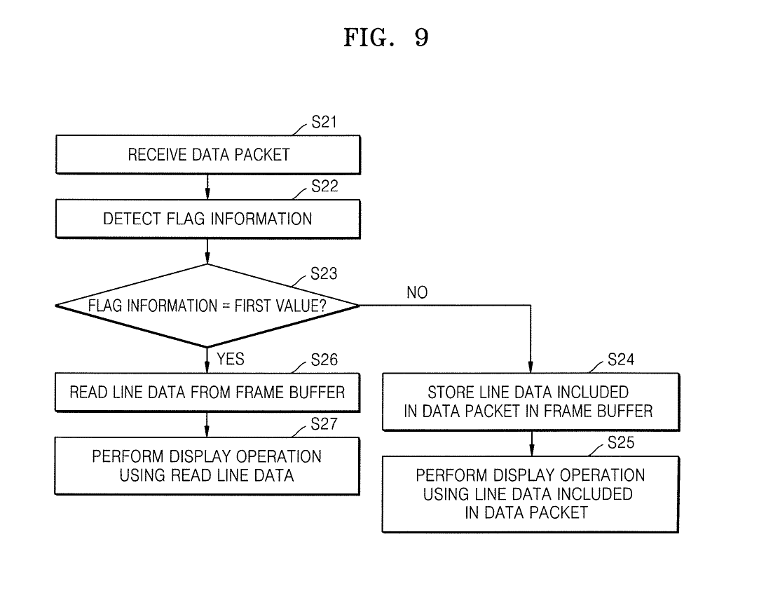

FIG. 8 is a flowchart of a method of operating a system on chip according to an exemplary embodiment of the inventive concept.

As illustrated in FIG. 8, in operation S11, data of a previous frame and data of a current frame are received by accessing an internal or an external memory of the system on chip. Line data is compared with respect to the received frame data for a line unit in operation S12. For example, in operation S12, the line data of the previous frame and the line data of the current frame are compared with each other. In operation S13, it is determined whether the line data of the previous frame and the line data of the current frame are the same.

When at least one piece of the line data of the current frame is different from the line data of the previous frame, the line data of the current frame is used to perform a display operation. Thus, when the line data is determined to be different in operation S13, flag information is set to have a second value indicating that the display operation is to be performed using line data of the current frame included in a data packet in operation S14. In operation S15, the data packet including both the flag information and the line data of the current frame may be generated. In operation S18, the generated data packet may be transferred to a display driving circuit.

In contrast, when the line data of the current frame and the line data of the previous frame are determined to be the same in operation S13, the display operation may be performed using the line data of the previous frame, which is already stored in the display driving circuit, with respect to a corresponding line of the current frame. Accordingly, in operation S16, the flag information is set to have a first value indicating that the display operation is be performed using line data already stored in a frame buffer in the display driving circuit. Thus, when the line data is determined to be the same in operation S13, a data packet that does not include line data of the current frame may be generated in operation S17. In operation S18, the generated data packet may be transferred to the display driving circuit.

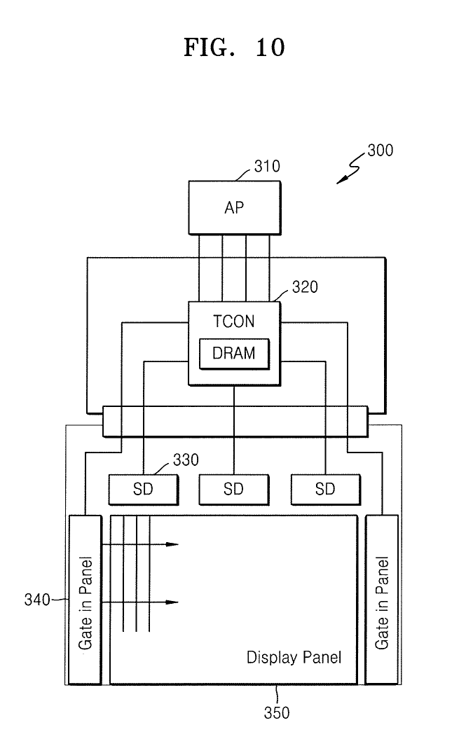

FIG. 9 is a flowchart of a method of operating a display driving circuit according to an exemplary embodiment of the inventive concept.

As illustrated in FIG. 9, the display driving circuit may receive a data packet from a host in operation S21, and may detect flag information included in the received data packet in operation S22. Once the flag information has been detected, it is determined whether the flag information has a first value in operation S23. As described above, flag information having a first value indicates that line data of a current frame and line data of a previous frame are the same, and flag information having a second value, different from the first value, indicates that line data of a current frame and line data of a previous frame are different.

When it is determined in operation S23 that the flag information has a second value, which indicates that line data of a current frame and line data of a previous frame are different, the display driving circuit stores line data included in the data packet in a corresponding region of a frame buffer in operation S24. This operation may correspond to, for example, an operation of updating the line data of the previous frame stored in the corresponding portion of the frame buffer with the line data of the current frame. In operation S25, a display operation is performed using the line data included in the data packet. The line data may be extracted from the data packet and may be used to perform the display operation, or the line data updated in the frame buffer may be used to perform the display operation.

When it is determined in operation S23 that the flag information has a first value, which indicates that the line data of the current frame and the line data of the previous frame are the same, the display driving circuit displays a corresponding line of the current frame using the line data of the previous frame. Accordingly, the display driving circuit reads line data to be displayed from the frame buffer in operation S26, and performs the display operation using the read line data in operation S27.

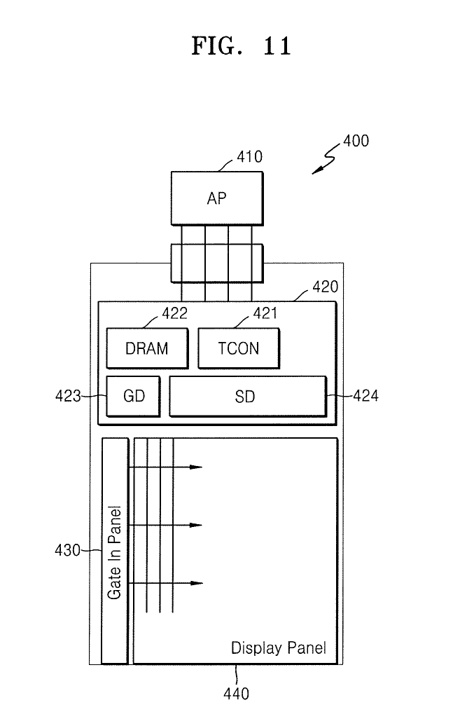

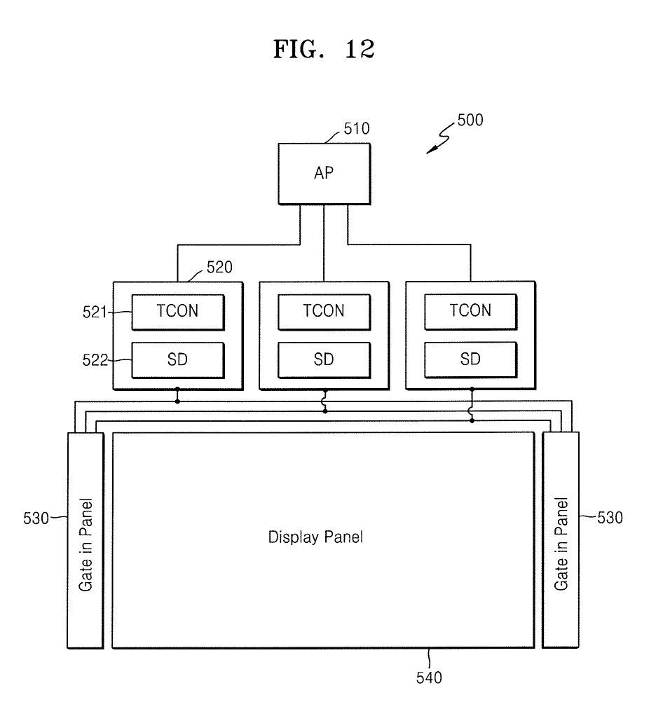

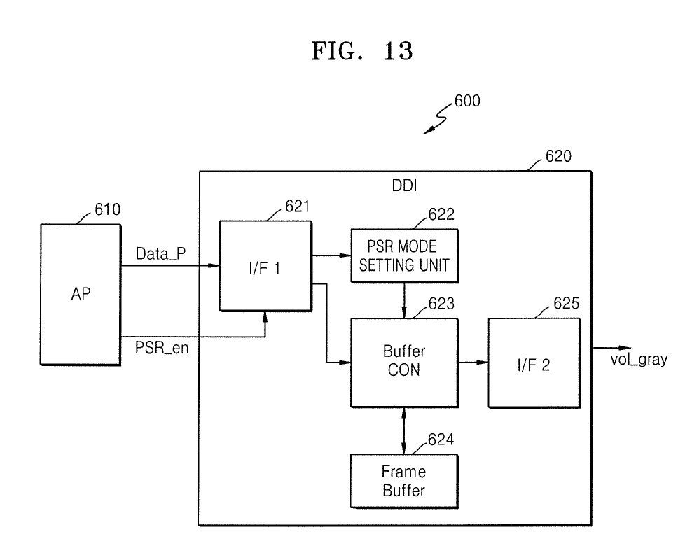

FIGS. 10 through 12 are block diagrams of display systems 300, 400, and 500 respectively including display driving circuits 320, 420, and 520 according to exemplary embodiments of the inventive concept. FIG. 10 illustrates an example in which a timing controller and a source driver are implemented as separate chips. FIGS. 11 and 12 illustrate an example in which the timing controller and the source driver are implemented in the same chip. Herein, the display driving circuit may be defined as a circuit including one or more of the IP blocks (e.g., functional blocks) shown in FIGS. 10 through 12 related to the driving of a display panel. For example, in FIG. 10, the timing controller 320 may be referred to as the display driving circuit 320.

Referring to FIG. 10, the display system 300 may include an application processor 310, a timing controller 320, at least one source driver 330, a display panel 350, and at least one gate 340 disposed in the display panel 350 or adjacent to the display panel 350. The timing controller 320 may include a frame buffer storing one or more pieces of frame data. In the exemplary embodiment of FIG. 10, an example in which the frame buffer is implemented using DRAM will be illustrated (e.g., the display driving circuit 320 includes DRAM as the frame buffer). As described above, in the exemplary embodiment of FIG. 10, the display driving circuit may correspond to the timing controller 320.

The application processor 310 may receive two or more pieces of frame data by accessing a memory disposed inside or outside of the application processor 310, and may perform the operation of comparing data for a line unit as described above. As described above, the application processor 310 may generate a data packet including flag information according to a result of the comparison, and the data packet may or may not include line data according to the result of the comparison.

The timing controller 320 may generate various timing information for controlling a display operation, and may output grayscale data via the at least one source driver 330. The source driver 330 may generate an analog grayscale voltage according to the received grayscale data, and may provide the generated analog grayscale voltage to the display panel 350. As described above, the timing controller 320 may detect flag information included in the data packet received from the application processor 310. According to a result of the detection, the timing controller 320 may output line data of a current frame, which is included in the data packet, as grayscale data, or the timing controller 320 may read line data stored in the frame buffer included in the timing controller 320 and output the read line data as grayscale data.

Referring to FIG. 11, according to an exemplary embodiment, a display system 400 may include an application processor 410, a display driving circuit 420, a display panel 440, and at least one gate 430 disposed inside of or adjacent to the display panel 440. The display driving circuit 420 may include a timing controller 421, a frame buffer 422 (e.g., implemented as a DRAM), a gate driver 423, and a source driver 424. In FIG. 11, the display driving circuit 420 may be defined as a circuit including the timing controller 421, the gate driver 423, and the source driver 424 as various circuits used for driving the display panel 440. As shown in FIG. 11, in an exemplary embodiment, the frame buffer 422 may be disposed outside of the timing controller 421. However, exemplary embodiments are not limited thereto.

The application processor 410 may communicate with the timing controller 421 in the display driving circuit 420. Accordingly, a data packet may be transferred between the application processor 410 and the display driving circuit 420.

Referring to FIG. 12, in an exemplary embodiment, a display system 500 may include an application processor 510, one or more display driving circuits 520, a display panel 540, and one or more gates 530 inside of or adjacent to the display panel 540.

Each display driving circuit 520 may include a timing controller 521 and a source driver 522. Each display driving circuit 520 may include a frame buffer. The frame buffer may be included, for example, in the timing controller 521, or outside of the timing controller 521. In exemplary embodiments that include a plurality of display driving circuits 520, such as the exemplary embodiment of FIG. 12, each display driving circuit 520 may control a display operation of a partial region of the display panel 540. Further, the frame buffer included in each of the plurality of display driving circuits 520 may store only data of a certain region corresponding to a portion of the display panel 540.

In the exemplary embodiments of FIGS. 10 through 12, the power consumption for an interface between the application processor and the display driving circuit, and the power consumption for writing data in the frame buffer, may be reduced. Further, transition may be minimized when data is transferred, and thus, electro-magnetic interference (EMI) characteristics may be improved.

Although FIGS. 10 through 12 illustrate the frame buffer as being implemented using DRAM, exemplary embodiments are not limited thereto. For example, the frame buffer may be a type of a volatile memory such as, for example, SRAM, or other types of nonvolatile memories such as, for example, flash or resistive memory. Further, as in the above-described exemplary embodiments, even when the line data of the previous frame and the line data of the current frame are the same, and thus, the line data does not have to be updated in the frame buffer, as described above, exemplary embodiments may operate such that a refresh operation is performed with respect to the region corresponding to the frame buffer so that the reliability of the data stored in the frame buffer is maintained.

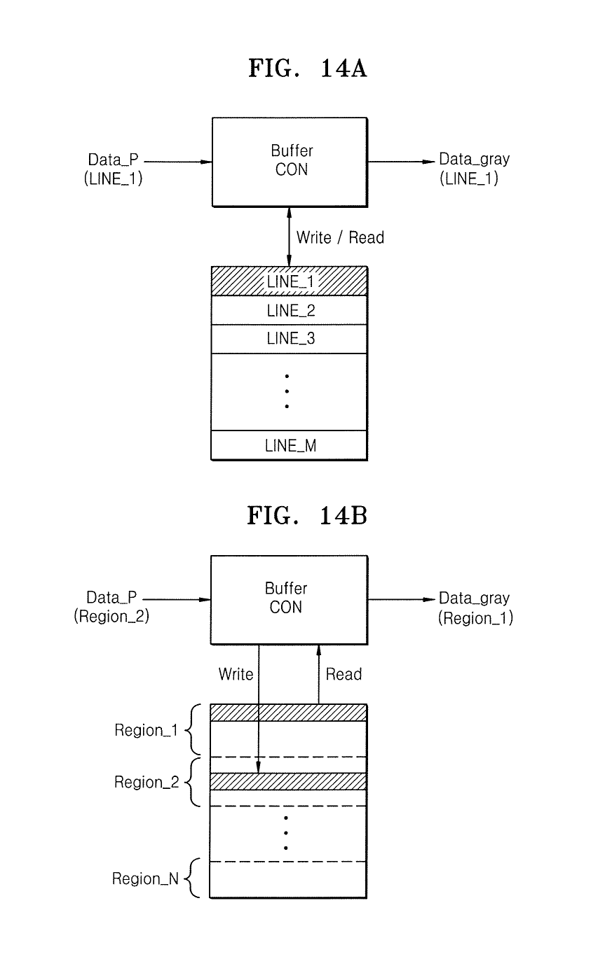

FIG. 13 is a block diagram of an image processing system 600 according to an exemplary embodiment of the inventive concept. As illustrated in FIG. 13, the image processing system 600 may include an application processor 610 and a display driving circuit 620. The display driving circuit 620 may include a first interface unit 621, a PSR mode setting unit 622, a buffer controller 623, a frame buffer 624, and a second interface unit 625.

The application processor 610 generates a data packet Data_P including line data or not including line data, as described above, and provides the data packet Data_P to the display driving circuit 620, according to any one of the above-described exemplary embodiments. When data of a current frame which is to be displayed and data of a previous frame are the same, the application processor 610 may activate a PSR enable signal PSR_en and provide the activated PSR enable signal PSR_en to the display driving circuit 620.

The display driving circuit 620 receives the data packet Data_P via the first interface unit 621 and processes the received data packet Data_P. If the PSR enable signal PSR_en is activated, the first interface unit 621 may be disabled in response to the activated PSR enable signal PSR_en, and the PSR mode setting unit 622 may provide a signal to the buffer controller 623 indicating that the PSR mode is being entered. The buffer controller 623 may then perform a display operation using a plurality of pieces of line data stored in the frame buffer 624 regardless of communication with the outside. For example, in an exemplary embodiment, the buffer controller 623 may control a display operation such that the display operation is performed using frame data stored in the frame buffer 624 and not using external line data from outside of the display driving circuit 620 while in a first mode (e.g., the PSR mode), and such that the display operation is performed using at least one of the frame data stored in the frame buffer 624 and the external line data provided from outside of the display driving circuit 620 on a line-by-line basis while in a second mode. In an exemplary embodiment, the buffer controller 623 is configured to provide local first line data stored in the frame buffer 624 as grayscale data in response to determining that first line data of a previous frame and first line data of a current frame are identical, and provide external first line data provided from outside of the display driving circuit 620 as the grayscale data in response to determining that the first line data of the previous frame and the first line data of the current frame are different.

When the PSR mode has ended, the display driving circuit 620 may perform the display operation according to the data packet Data_P provided from the application processor 610. As in the above-described exemplary embodiments, the display operation may be performed by detecting the flag information included in the data packet Data_P and by using the line data included in the data packet Data_P or the line data stored in the frame buffer 624 as grayscale data according to a result of the detection. A grayscale voltage vol_gray may be generated by an additional data process with respect to the grayscale data, and the generated grayscale voltage vol_gray may be provided to a display panel via the second interface unit 625.

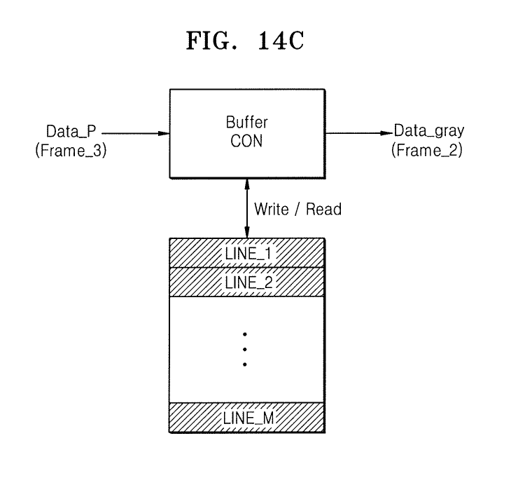

FIGS. 14A, 14B, and 14C show an example of writing and reading operations of a frame buffer according to exemplary embodiments of the inventive concept.

Referring to FIG. 14A, a data packet Data_P may be provided to a display driving circuit to drive any one of a plurality of lines of a current frame (e.g., a first line LINE_1), and the display driving circuit may perform a display operation with respect to the first line LINE_1 of the current frame in correspondence to the received data packet Data_P. Pieces of line data of M lines LINE_1 through LINE_M (where M is an integer greater than or equal to 2) of a previous frame may be stored in the frame buffer.

A buffer controller may detect flag information included in the data packet Data_P. When the flag information has the first value (e.g., a value indicating that the line data is the same), the buffer controller may output first line data stored in the frame buffer as grayscale data Data gray with respect to the first line LINE_1. Alternatively, when the flag information has a second value (e.g., a value indicating that the line data is different), the buffer controller may store first line data included in the received data packet Data_P in the frame buffer and output the first line data included in the data packet Data_P as grayscale data Data gray. That is, the display driving circuit may perform the operation of receiving the data packet Data_P related to the line of the current frame and the display operation with respect to the line in series.

Referring to FIG. 14B, the writing and reading operations with respect to the frame buffer may be performed in a region unit. For example, a frame may be divided into a plurality of regions Region_1 through Region_N (where N is an integer greater than or equal to 2), and each region may store a plurality of pieces of line data.

M pieces of line data LINE_1 through LINE_M of the previous frame may be stored in the frame buffer (where M is an integer greater than or equal to 2), and pieces of line data for displaying the current frame may be provided to the buffer controller as the data packet Data_P. The buffer controller may detect flag information included in each data packet, and selectively write line data included in the data packet into the frame buffer according to a result of the detection, as described above.

After data packets with respect to a region of the current frame are received, a display operation with respect to the current frame may be started. For example, at least some of a plurality of pieces of line data of a first region Region_1 of the frame buffer may be updated by receiving a data packet Data_P with respect to the first region Region_1 of the frame buffer, and when pieces of line data of another region (e.g., a second region Region_2) of the frame buffer are updated, pieces of line data stored in the first region Region_1 of the frame buffer may be used to perform the display operation. As illustrated in FIG. 14B, the buffer controller may update the pieces of line data by receiving a data packet Data_P with respect to the second region Region_2 of the frame buffer, and may sequentially read the pieces of line data stored in the first region

Region_1 and output the read pieces of line data as grayscale data.

Referring to FIG. 14C, after all of the data packets Data_P with respect to the current frame are received and pieces of line data are selectively updated according to flag information of the plurality of data packets Data_P, the display operation may be performed using the pieces of line data stored in the frame buffer. After the plurality of data packets Data_P with respect to the current frame (e.g., a second frame Frame_2) are received and some of pieces of line data are updated, the buffer controller may receive a data packet Data_P with respect to a next frame (e.g., a third frame Frame_3). The buffer controller may process the data packet Data_P with respect to the next frame Frame_3, may read pieces of line data of the current frame Frame_2 stored in the frame buffer, and may output the read pieces of line data as grayscale data Data_gray.

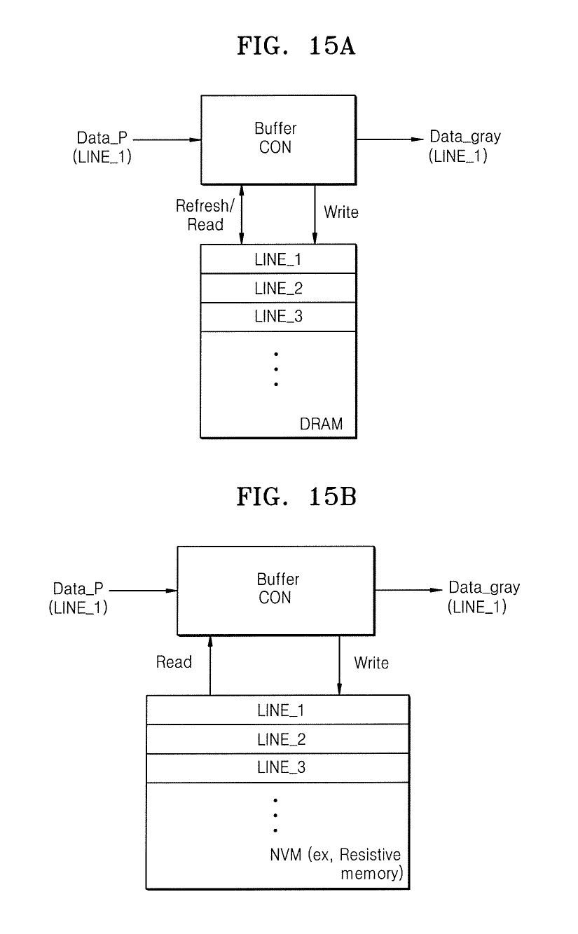

FIGS. 15A and 15B are views of another example of writing and reading operations of a frame buffer according to exemplary embodiments of the inventive concept. FIG. 15A illustrates an example in which the frame buffer is implemented as a volatile memory such as, for example, DRAM. FIG. 15 illustrates an example in which the frame buffer is implemented as a nonvolatile memory such as, for example, resistive memory.

As described above, the buffer controller may detect flag information included in the data packet Data_P and may control an access operation with respect to the frame buffer according to a result of the detection. As illustrated in FIG. 15A, pieces of line data of a previous frame are stored in the frame buffer, and a data packet Data_P including or not including line data of a current frame may be provided to the buffer controller.

When the flag information has a first value (e.g., indicating that first line data LINE_1 of the previous frame and first line data LINE_1 of the current frame are the same), the buffer controller may refresh a corresponding line (e.g., a first line) of the frame buffer without an additional writing operation with respect to the frame buffer. In addition, the buffer controller may read the first line data LINE_1 and output the read first line data LINE_1 as grayscale data Data_gray. Alternatively, when the flag information has a second value (e.g., indicating that the first line data LINE_1 of the previous frame and the first line data LINE_1 of the current frame are different), the buffer controller may write the first line data included in the data packet Data_P into the frame buffer, and may read the written first line data and output the read first line data as grayscale data Data_gray.

Referring to FIG. 15B, the refresh operation may not be performed according to a memory included in the frame buffer. When the flag information has the first value (e.g., indicating that the first line data LINE_1 of the previous frame and the first line data LINE_1 of the current frame are the same), the buffer controller may read the first line data and output the read first line data as grayscale data Data_gray without an additional writing and refreshing operation. Alternatively, when the flag information has the second value (e.g., indicating that the first line data LINE_1 of the previous frame and the first line data LINE_1 of the current frame are different), the buffer controller may write the first line data included in the data packet Data_P into the frame buffer, and may read the written first line data and output the read data as grayscale data Data_gray.

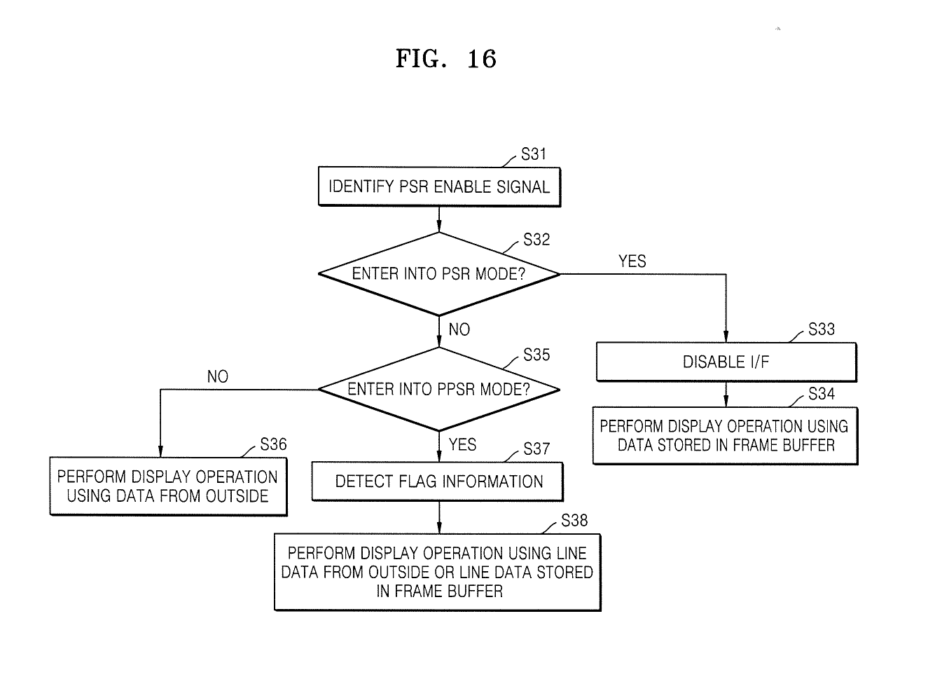

FIG. 16 is a flowchart showing a method of operating a display driving circuit according to an exemplary embodiment of the inventive concept.

As illustrated in FIG. 16, the display driving circuit may receive a PSR enable signal from an external host (e.g., an application processor, etc.) and may identify whether the PSR enable signal is activated in operation S31. According to a result of the identification, the display driving circuit may determine whether to enter into a PSR mode in operation S32.

When the display driving circuit enters into the PSR mode, at least some elements (e.g., IP blocks) of the display driving circuit used to interface with the host may be disabled in operation S33. For example, a circuit in the display driving circuit used for communicating with the host may be shut down, thereby reducing power consumption used for communication with the host. Accordingly, the data packets with respect to the current frame are not provided to the display driving circuit and a display operation is performed using pieces of line data of a previous frame (which are stored in a frame buffer in the display driving circuit) in operation S34.

When the PSR mode is not entered into or when the PSR mode is ended, the display operation may be performed according to a result of detecting flag information, as described above. A mode in which the operation according to the present exemplary embodiment is performed may be defined as a partial panel self refresh (PPSR) mode, which is described further below. Information indicating whether the PPSR mode is performed may be pre-set and stored in the host or the display controller.

In operation S35, it is determined whether the PPSR mode is to be entered into. When the PPSR mode is not entered into, the display operation may be performed according to a normal display method. For example, when the PSR mode is ended, even when line data of only a region of the previous frame and the current frame is changed, the display driving circuit may receive the entire line data of the current frame from the outside and may perform the display operation using the received line data in operation S36. All of the lines of the frame buffer in the display driving circuit may be updated by the line data of the current frame.

Alternatively, when the PPSR mode is entered into, flag information included in a data packet may be detected in operation S37, as described above, and the display operation may be performed using line data provided from the outside or line data stored in the frame buffer according to a result of the detection in operation S38.

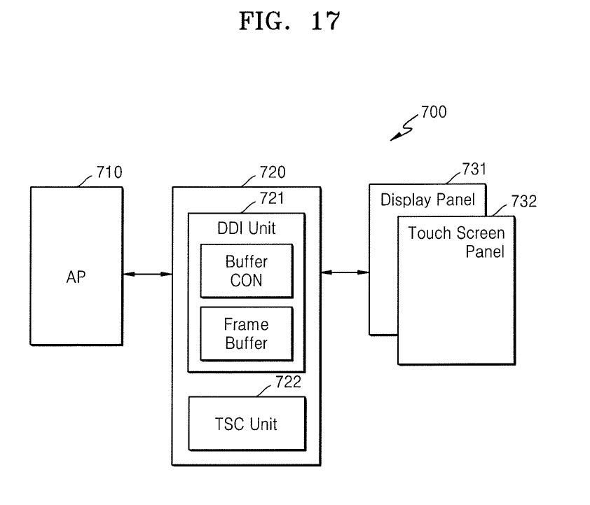

FIG. 17 is a block diagram of an image processing system 700 according to an exemplary embodiment of the inventive concept.

As illustrated in FIG. 17, the image processing system 700 may include an application processor 710, a display module 720, and a panel unit. The panel unit may include a display panel 731 outputting an image and a touch screen panel 732. The display module 720 may include a display driving circuit unit 721 and a touch screen control unit 722. The display driving circuit unit 721 may perform the operation of detecting flag information and the accessing operation with respect to a frame buffer, as described above. Accordingly, the display driving circuit unit 721 may include a buffer controller and a frame buffer, as shown in FIG. 17.

The display module 720 may be implemented as one semiconductor chip, and thus, a display driving function and a touch screen control function may be integrated in the semiconductor chip. The display driving circuit unit 721 may include a timing controller, a gate driver, and a source driver, which may be used for the display driving function. To implement the touch screen control function, the touch screen control unit 722 may include a detection unit for detecting a capacitance element of a sensing unit included in the touch screen panel 732, and a touch data generating unit for generating touch data according to a result of the detection. The display driving circuit 721 and the touch screen control unit 722 may exchange at least one signal. For example, the touch screen control unit 722 may perform a touch screen control operation using the signal from the display driving circuit 721. For example, the display driving circuit unit 721 may generate at least one piece of timing information related to driving the display, and the touch screen control unit 722 may perform a touch screen control operation based on the timing information.

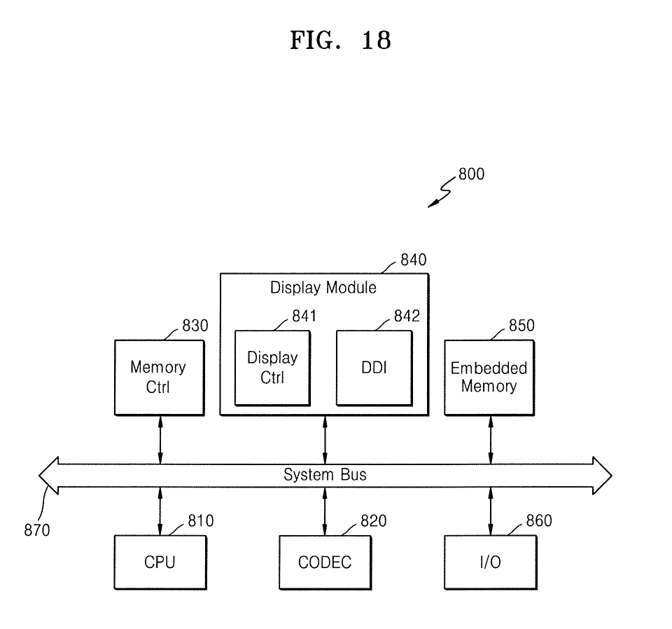

FIG. 18 is a block diagram of an SoC 800 according to an exemplary embodiment of the inventive concept. The SoC 800 of FIG. 18 may correspond to, for example, an application processor.

As illustrated in FIG. 18, the SoC 800 may include various IP blocks for performing an application processor function. For example, the SoC 800 may include a central processing unit 810, a codec module 820, a memory control module 830, a display module 840, an embedded memory 850, and an input/output module 860. A display operation function of the display driving circuit may be included in the SoC 800, and thus, the display module 840 may include a display control unit 841 and a display driving circuit unit 842. The above-described elements may be connected with one another via a system bus 870 in the SoC 800. The elements of FIG. 18 which are the same as the elements of FIG. 2 have the same operations as those of the elements of FIG. 2, and for convenience of explanation, further description of these elements is omitted herein.

The display control unit 841 may perform a data comparison operation for a line unit with respect to at least two frames, and may control an output operation of line data according to a result of the comparison, as described above. For example, when line data of a previous frame and line data of a current frame are the same, the information indicating that the line data of the previous frame and the current frame is the same may be provided to the display driving circuit 842. According to the information, the display driving circuit 842 may read line data stored in a frame buffer included in the display driving circuit 842, and may generate a grayscale voltage according to the read line data and provide the grayscale voltage to a display panel outside of the display driving circuit 842.

Alternatively, when at least one piece of data of the line data of the previous frame and the current frame is different, the information indicating that the at least one piece of data of the line data of the previous frame and the current frame is different, together with the line data of the current frame, may be provided to the display driving circuit 842. The display driving circuit 842 may update the received line data in the frame buffer, and may generate a grayscale voltage according to the received line data and provide the grayscale voltage to the display panel outside of the display driving circuit 842.

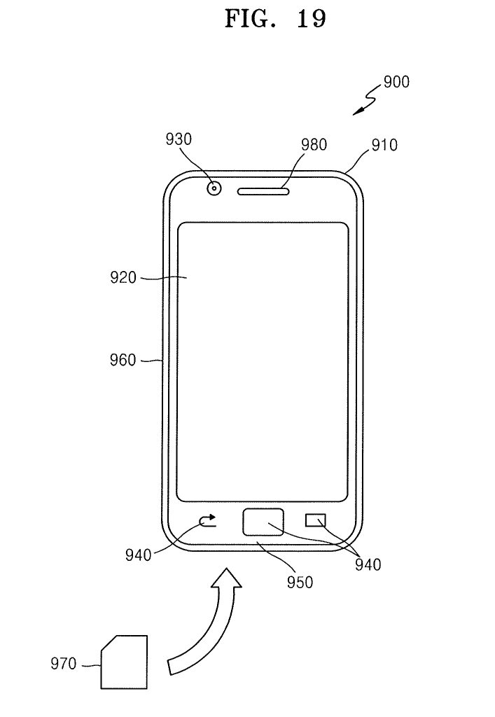

FIG. 19 shows an example of a portable terminal 900 in which an SoC and a display driving circuit according to an exemplary embodiment of the inventive concept are mounted. An application processor used to implement the SoC may be mounted in the portable terminal 900. The portable terminal 900 is not limited to particular functions, and may be, for example, a tablet computer or a smartphone, whose functions may be changed or expanded via an application program. The portable terminal 900 may include an antenna 910 and a display device 920 such as, for example, a liquid crystal display (LCD) or an organic light-emitting diode (OLED) for displaying images. The images displayed may be, for example, images captured by a camera 930 of the portable terminal 900 or images received via the antenna 910. The display device 920 may include a display panel and a display driving circuit. According to an exemplary embodiment, the display device 920 may receive a data packet provided from the application processor and perform a display operation according to a result of detecting flag information included in the received data packet, as described above.

The portable terminal 900 may further include an operation panel 940 that receives input from a user. The operation panel 940 may include, for example, a control button(s) and/or a touch panel. The portable terminal 900 may further include a speaker 980 for outputting a sound or a voice (or another type of sound outputting unit) and a microphone 950 into which the sound or the voice may be input (or another type of sound inputting unit). The camera 930 may utilize, for example, a reduction type linear sensor (e.g., a CCD sensor) or a contact image sensor (e.g., a CIS sensor) for capturing videos and still images. The portable terminal 900 may further include a storage medium 970 for storing encoded or decoded data, such as the video and the still image captured by the camera 930, received through an email, or obtained by other methods, and a slot 960 for mounting the storage medium 970 in the portable terminal 900. The storage medium 970 may be, for example, an SD card, a microSD card, or other types of flash memories, such as electrically erasable and programmable read only memory (EEPROM) mounted in a plastic case.

While the inventive concept has been particularly shown and described with reference to the exemplary embodiments thereof, it will be understood by those of ordinary skill in the art that various changes in form and detail may be made therein without departing from the spirit and scope of the inventive concept as defined by the following claims.

1. A display driving circuit, comprising:
a frame buffer configured to store a plurality of pieces of line data; and
a buffer controller configured to receive a data packet, and output first line data included in the data packet or second line data stored in the frame buffer as grayscale data based on flag information included in the data packet.

2. The display driving circuit of claim 1, wherein the plurality of pieces of line data stored in the frame buffer includes line data of a plurality of lines of a first frame, and
the buffer controller is configured to receive a plurality of data packets corresponding to a plurality of lines of a second frame, and control a display operation such that a portion of the second frame is displayed using the second line data stored in the frame buffer and another portion of the second frame is displayed using third line data included in the plurality of data packets corresponding to the second frame based on flag information included in the plurality of data packets.

3. The display driving circuit of claim 1, wherein the buffer controller comprises:
a flag detection unit configured to detect the flag information included in the data packet; and
an access control unit configured to control access of the frame buffer based on the flag information.

4. The display driving circuit of claim 3, wherein the access control unit is configured to read the second line data stored in the frame buffer and provide the second line data as the grayscale data in response to the flag information having a first value, and provide the first line data included in the data packet as the grayscale data in response to the flag information having a second value.

5. The display driving circuit of claim 4, wherein the access control unit is configured to write the first line data included in the data packet to the frame buffer in response to the flag information having the second value.

6. The display driving circuit of claim 1, wherein the buffer controller is configured to refresh line data corresponding to a first line of a frame and stored in the frame buffer in response to the flag information included in the data packet corresponding to the first line having a first value, and
the buffer controller is configured to update the line data corresponding to the first line and stored in the frame buffer with the first line data included in the data packet in response to the flag information included in the data packet having a second value.

7. The display driving circuit of claim 1, further comprising:
a source driver configured to receive the grayscale data, and generate a grayscale voltage provided to a display panel by processing the received grayscale data.

8. The display driving circuit of claim 1, wherein the display driving circuit is a timing controller configured to provide the grayscale data to a source driver.

9. The display driving circuit of claim 1, wherein the data packet is encoded and does not include line data of a current frame when line data of a previous frame and the line data of the current frame are identical.

10. A display driving circuit, comprising:
a frame buffer configured to store frame data comprising a plurality of pieces of line data; and
a buffer controller configured to control a display operation such that the display operation is performed using the frame data stored in the frame buffer and not using external line data from outside of the display driving circuit while in a first mode, and such that the display operation is performed using at least one of the frame data stored in the frame buffer and the external line data provided from outside of the display driving circuit on a line-by-line basis while in a second mode.

11. The display driving circuit of claim 10, wherein the first mode is a panel self-refresh (PSR) mode in which data communication with an application processor is disabled.

12. The display driving circuit of claim 10, wherein the buffer controller is configured to receive a plurality of data packets corresponding to a plurality of lines of a current frame, and at least some of the data packets do not comprise line data.

13. The display driving circuit of claim 10, wherein the buffer controller is configured to skip a line data writing operation with respect to the frame buffer, or perform the line data writing operation with respect to the frame buffer using the external line data included in a data packet provided from outside of the display driving circuit, according to flag information included in the data packet.

14. The display driving circuit of claim 13, wherein the buffer controller is configured to read the line data stored in the frame buffer and output the read line data as grayscale data in response to determining that the flag information has a first value, and output the external line data included in the data packet as the grayscale data in response to determining that the flag information has a second value.

15. The display driving circuit of claim 10, wherein the plurality of pieces of line data stored in the frame buffer comprises a first plurality of pieces of line data corresponding to a previous frame and a second plurality of pieces of line data corresponding to a current frame, and the buffer controller is configured to selectively receive some of the second plurality of pieces of line data corresponding to the current frame.

16. The display driving circuit of claim 15, wherein the buffer controller is configured to provide local first line data stored in the frame buffer as grayscale data in response to determining that first line data of the previous frame and first line data of the current frame are identical, and provide external first line data provided from outside of the display driving circuit as the grayscale data in response to determining that the first line data of the previous frame and the first line data of the current frame are different.

17. A system on chip (SoC), comprising:
a memory control module; and
a display control module configured to compare pieces of line data of a first frame with pieces of line data of a second frame, transfer a first data packet which does not comprise a first piece of the line data of the second frame that corresponds to a first piece of the line data of the first frame in response to a first comparison result indicating that the first pieces of the line data are identical, and transfer a second data packet which comprises a second piece of the line data of the second frame that corresponds to a second piece of the line data of the first frame in response to the first comparison result indicating that the second pieces of the line data are different.

18. The SoC of claim 17, wherein the first and second data packets each comprise flag information having values indicating the first comparison result.

19. The SoC of claim 17, wherein the display control module comprises:
a comparison unit configured to compare a piece of the line data of the second frame corresponding to a current frame with a piece of the line data of the first frame corresponding to a previous frame; and
a packet generating unit configured to generate a third data packet,
wherein the third data packet comprises flag information having a first value indicating that the piece of the line data of the second frame corresponding to the current frame and the piece of the line data of the first frame corresponding to the previous frame are identical, and does not comprise the piece of the line data of the second frame corresponding to the current frame, in response to a second comparison result indicating that the piece of the line data of the second frame corresponding to the current frame and the piece of the line data of the first frame corresponding to the previous frame are identical.

20. The system on chip of claim 17, wherein the display control module comprises:
a comparison unit configured to compare the pieces of line data of the first frame with the pieces of line data of the second frame; and
a panel self-refresh (PSR) management unit configured to prevent the first and second data packets from being output when all of the pieces of line data of the first frame and all of the pieces of line data of the second frame are identical.

21-29. (canceled)
